(19) United States
(12) Patent Application Publication
(10) Pub. No.: US 2015/0245605 A1
(43) Pub. Date: Sep. 3, 2015

(54) Multiple Position Handle

(71) Applicant: Raymond P. Stempka, Erie, PA (US)

(72) Inventor: Raymond P. Stempka, Erie, PA (US)

(21) Appl. No.: 14/635,582

(22) Filed: Mar. 2, 2015

Related U.S. Application Data
(60) Provisional application No. 61/945,901, filed on Feb. 28, 2014.

(51) Int. Cl. A01M 31/00; B65G 7/12

(52) U.S. Cl. CPC A01M 31/006; B65G 7/12

(57) ABSTRACT

An apparatus for dragging heavy loads includes a structural body, a first rope hole, a handle hole, and a first set of finger notches. The first rope hole traverses through the structural body allowing a user to attach a rope. The user holds the apparatus by inserting the hand into the handle hole. Once the hand is inserted into the handle hole the fingers of the user rest within the first set of finger notches. A left wing and a right wing are adjacently connected to the structural body. A second set of finger notches are integrated into a distal longitudinal lateral surface of the left wing for a second user. Likewise, a third set of finger notches are integrated into a distal longitudinal lateral surface of the right wing for a third user. A second rope hole and a third rope hole provide multiple attachment points.

The current application claims a priority to the U.S. Provisional Patent application Ser. No. 61/945,901 filed on Feb. 28, 2014. The current application is filed on Mar. 2, 2015 while Feb. 28, 2014 was on a weekend.

### FIELD OF THE INVENTION

The present invention relates generally to devices used for dragging heavy loads. More specifically, the present invention is an apparatus with multiple handles that allows multiple users to drag a load which is attached to the apparatus through a rope.

### BACKGROUND OF THE INVENTION

As experienced by many hunters, dragging a carcass can be a daunting task. The difficulty of the task increases with the weight of the carcass. For instance, if the weight of the carcass is significantly large, multiple hunters may be required to carry away the carcass.

Hunters usually utilize a rope to drag away a carcass. One end of the rope is secured around the carcass, and the hunter drags the carcass by clinging onto the other end of the rope. However, dragging a rope for a lengthy time period applies significant pressure on the hunter's hand. In order to prevent injuries and also to make dragging the carcass easier, hunters often use a stick at the free end of the rope. Even though the stick reduces the pressure applied on the hand of the hunter, the stick may not be sufficient for dragging significantly heavy loads or when dragging a carcass across an uneven terrain.

The need for a convenient method of dragging a heavy load has been identified and addressed through multiple devices. However, these devices come with a series of disadvantages. One significant disadvantage is the inability for multiple users to utilize the apparatus. In particular, most devices used for dragging are designed to be used by a single user. Therefore, these dragging devices are not beneficial when attempting to drag a large carcass.

Another disadvantage of existing dragging devices is the weight of the apparatus. Most hunters prefer to carry only the most essential items required for hunting, since carrying additional weight can be disadvantageous when moving around in a rough terrain.

Most existing dragging devices are attached to the rope at a single attachment point. Therefore, the rope undergoes significant tension when a heavy load is attached at the other end of the rope. The tension is especially disadvantageous if the carcass is being loaded onto a higher platform such as a truck. Considering the above mentioned disadvantages, it is clearly evident that a much more efficient dragging device is necessary.

The objective of the present invention is to address the aforementioned issues. The present invention introduces an apparatus that can be used by either one user or multiple users. In order to do so, the present invention is designed with multiple handles along the body of the apparatus. The present invention also provides multiple attachment points for the rope. As a result, the carcass can be dragged away with minimum tension on the rope. To avoid additional weight to the hunting gear of the hunter, the present invention is constructed in plastic, aluminum, wood, or any other comparable lightweight material. Additionally, the present invention is shaped and sized such that the hunter can conveniently carry the present invention in the pocket or a pouch.

### BRIEF DESCRIPTION OF THE DRAWINGS

FIG. 1 is a perspective view of the present invention.

FIG. 2 is a top view of the present invention.

FIG. 3 is a perspective view of the present invention illustrating a rope traversing through a first rope hole.

FIG. 4 is a bottom view of the present invention illustrating a rope traversing through a first rope hole.

FIG. 5 is a side view of the present invention illustrating the rope traversing through the first rope hole.

FIG. 6 is a top view illustrating a first portion and a second portion of another embodiment of the present invention.

### DETAIL DESCRIPTIONS OF THE INVENTION

All illustrations of the drawings are for the purpose of describing selected versions of the present invention and are not intended to limit the scope of the present invention.

The present invention is a device utilized to drag heavy loads. The preferred embodiment of the present invention is intended to be used by hunters to drag a carcass. By utilizing the present invention, a user can drag a heavy load with minimum strain on the hand which is essential when carrying a heavy load for a lengthy amount of time.

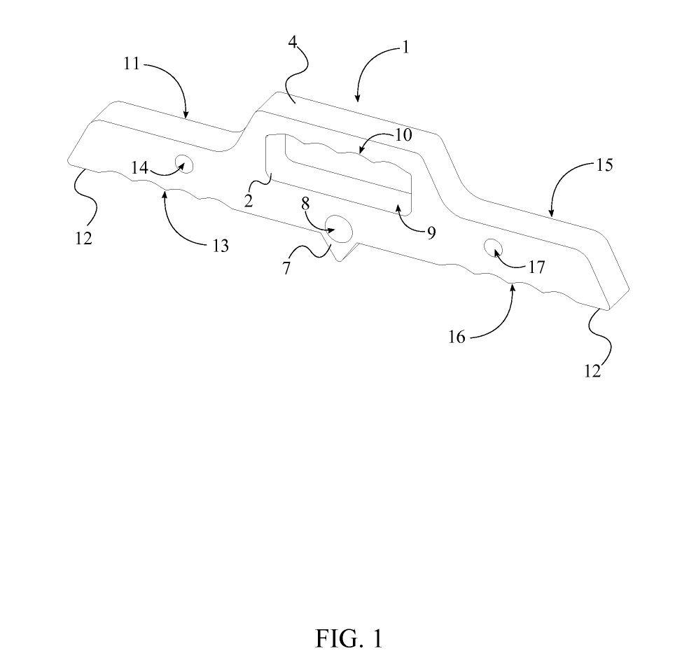

As seen in FIGS. 1-3, the present invention comprises a structural body 1, a first rope hole 8, a handle hole 9, and a first set of finger notches 10. The structural body 1 provides sturdiness to the present invention which is essential when dragging a heavy load. When the present invention is utilized, the user attaches one end of a rope to a carcass or similar load, and inserts the free end through the first rope hole 8. In order to control the attached load utilizing the present invention, the user inserts a hand into the handle hole 9. When the hand is positioned within the handle hole 9, the fingers of the user rest within the first set of finger notches 10. In order to receive the fingers of the user, each notch within the first set of finger notches 10 is semi-circular in shape.

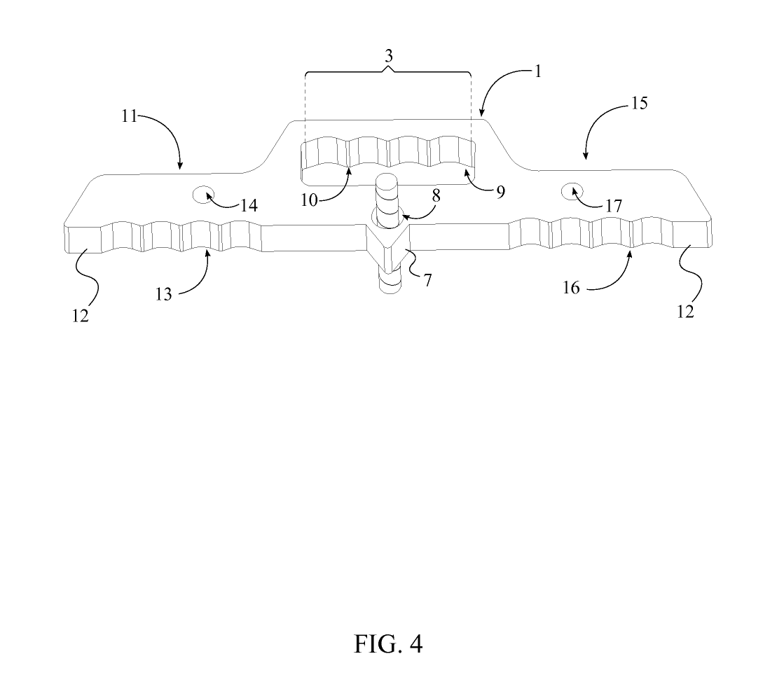

As illustrated in FIG. 1, the structural body 1 comprises an inner lateral surface 2 and an outer lateral surface 4. The handle hole 9 traverses through the structural body 1. As a result, the user is able to firmly grip the present invention by inserting the hand through the structural body 1. The handle hole 9 in the preferred embodiment of the present invention is sufficiently sized such that the user can conveniently insert the hand even with gloves on. As illustrated in FIG. 4, first set of finger notches 10 is integrated into a palm-width section 3 of the inner lateral surface 2. Moreover, the inner lateral surface 2 is delineated by the handle hole 9 such that the fingers of the user are pressed against the inner lateral surface 2 when the user holds the present invention.

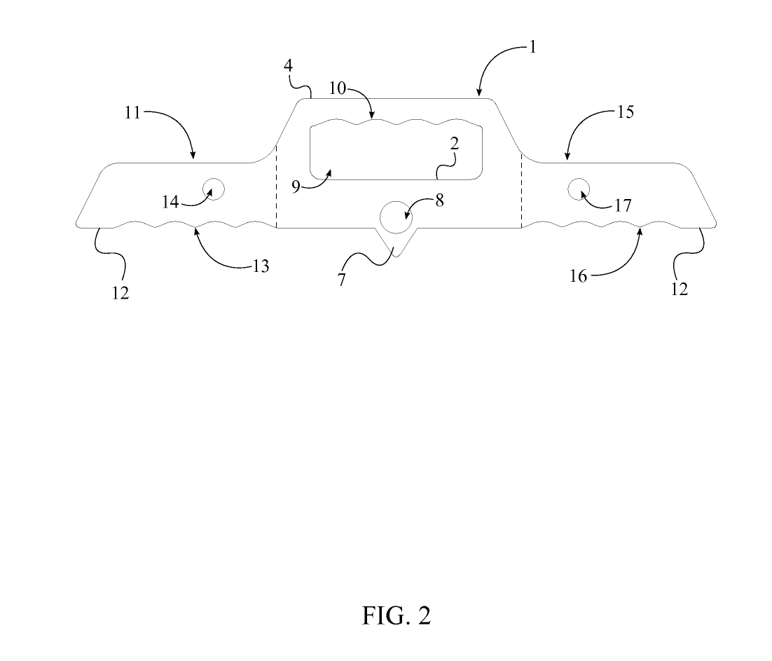

As discussed earlier, the rope is inserted into the first rope hole 8. The first rope hole 8 traverses through the structural body 1 such that the user can loop the rope through the structural body 1. By looping the rope through the first rope hole 8, the user establishes a firm connection between the rope and the present invention. The first rope hole 8 traverses through the structural body 1 parallel to the handle hole 9. Moreover, the first rope hole 8 is centrally oriented with the palm-width section 3 as illustrated in FIG. 2. The positioning of the first rope hole 8 is important to ensure that the force applied by the user is effectively transferred onto the rope. In order to be parallel to the handle hole 9, and also be centrally oriented with the palm-width section 3, the first rope hole 8 is positioned adjacent to the handle hole 9, opposite the first set of finger notches 10.

The present invention is designed such that multiple users can utilize the present invention simultaneously. In order to do so, the present invention comprises a left wing 11, a second set of finger notches 13, and a second rope hole 14. The left wing 11 is connected adjacent to the structural body 1 and is utilized to place the second set of finger notches 13. In particular, the second set of finger notches 13 is integrated into a distal longitudinal lateral surface 12 of the left wing 11. Similar to the first set of finger notches 10, the second set of finger notches 13 is appropriately shaped to receive the fingers of the user. In reference to the first set of finger notches 10, the left wing 11 is positioned opposite the first set of finger notches 10 across the handle hole 9. The left wing 11 is positioned adjacent to the first rope hole 8 such that the force applied by a second user at the left wing is successfully transferred onto the rope inserted into the first rope hole 8. The second rope hole 14 allows the user to attach the rope at multiple attachment points or use multiple ropes to drag the load. In order to do so, the second rope hole 14 traverses through the left wing 11. The second rope hole 14 is oriented in parallel to the first rope hole 8, such that any force applied by the user is evenly applied onto the load via the rope attached at the first rope hole 8 and the second rope hole 14.

The present invention also comprises a right wing 15, a third set of finger notches 16, and a third rope hole 17. Similar to the left wing 11, the right wing 15 is connected adjacent to the structural body 1 such that multiple users can utilize the present invention simultaneously. However, a single user can also utilize the left wing 11 and the right wing 15 in order to drag the weight with two hands. The third set of finger notches 16 is integrated into a distal longitudinal lateral surface 12 of the right wing 15, wherein the third set of finger notches 16 is appropriately shaped to receive the fingers of the user. The right wing 15 is positioned adjacent to the first rope hole 8 opposite the left wing 11. As a result of the positioning, the force applied at the right wing 15 effectively transfers onto the rope which is attached via the first rope hole 8. In reference to the handle hole 9, the right wing 15 is positioned opposite the first set of finger notches 10 across the handle hole 9. The third rope hole 17, similar to the second rope hole 14, allows the user to attach the rope at multiple attachment points or use multiple ropes. For instance, the second rope hole 14 and the third rope hole 17 are especially beneficial when dragging a wide load which requires the force to be applied at multiple points. The third rope hole 17 traverses through the right wing 15 and is oriented in parallel to the first rope hole 8. Resultantly, when the third rope hole 17 is utilized along with the first rope hole 8 and the second rope hole 14, the force is evenly applied onto the load via the rope which is attached at the first rope hole 8, the second rope hole 14, and the third rope hole 17.

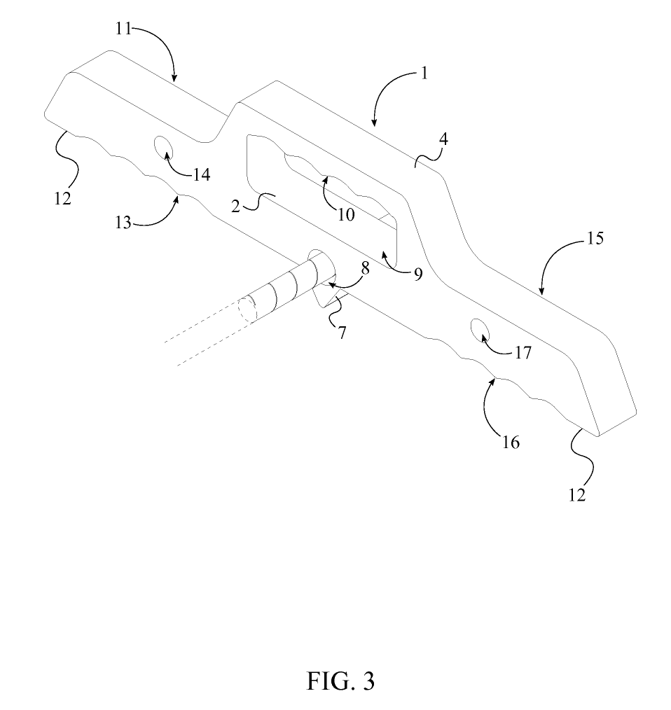

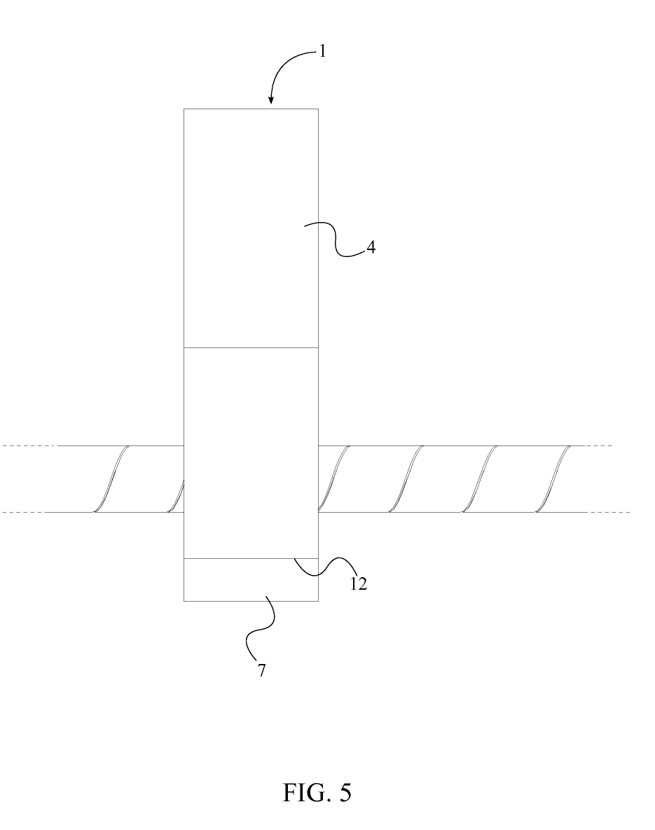

As shown in FIG. 3-5, the structural body 1 comprises a reinforced section 7. In the preferred embodiment of the present invention, the reinforced section 7 is positioned in between the left wing 11 and the right wing 15 and around the first rope hole 8. The positioning of the reinforced section 7 allows the user to conveniently insert the rope into the first rope hole 8, while providing stability to the portion of the structural body 1 around the first rope hole 8.

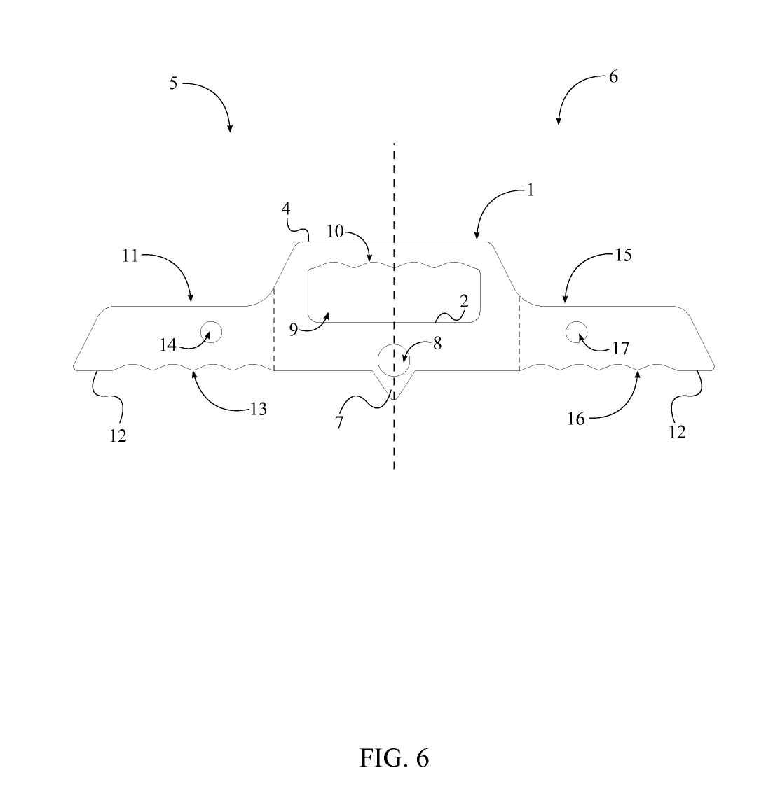

In the preferred embodiment of the present invention, the structural body 1 is designed as a single piece. However, in another embodiment of the present invention, the structural body 1 can comprise a first portion 5 and a second portion 6 as shown in FIG. 6. The first portion 5 and the second portion 6 allow the structural body 1 to fold about a given axis. The foldable configuration reduces the overall size of the present invention which is beneficial when transporting the present invention. In order to achieve the foldable configuration, the first portion 5 is hingedly connected to the second portion 6.

The present invention can be designed to fulfill different user requirements. For instance, if the user prefers the present invention to be sturdy, the present invention can be designed with materials that can be, but are not limited to, aluminum, steel, stainless steel or brass. However, if the user prefers the present invention to be lightweight, the present invention can be designed with materials that can be, but are not limited to wood, laminate, plastic, plastic-composite, or composite. Different manufacturing methods which can be, but are not limited to, laser production, water jet process, computer numerical control (CNC) milling, drop forged process, plastic injection molding, or 3-D printing can be utilized when producing the present invention.

When utilizing the present invention, the following procedure is followed. Initially, one end of the rope is attached to the load to be dragged. The preferred embodiment of the present invention is intended to be used as an apparatus used in hunting. In such instances, the rope is initially attached to a carcass. However, in other embodiments of the present invention, the rope can be attached to a different load. Next, the free end of the rope is inserted through the first rope hole 8 and is attached to the present invention. When the rope is securely attached to the present invention, the user controls the load by inserting the hand into the handle hole 9. When the hand is within the handle hole 9, the fingers of the user are positioned within the first set of finger notches 10. However, the user can also utilize the left wing 11 and the right wing 15 in order to drag the weight with two hands. Afterwards, the user can proceed to drag the attached load. In another instance, when multiple users are present, a second user holds onto the present invention with the second set of finger notches 13. Similarly, a third user holds onto the present invention with the third set of finger notches 16. If multiple ropes are required, a second rope is inserted through the second rope hole 14 and a third rope inserted through the third rope hole 17. By utilizing the present invention, the user or multiple users can drag a heavy load conveniently with minimum strain on the hand.

Although the invention has been explained in relation to its preferred embodiment, it is to be understood that many other possible modifications and variations can be made without departing from the spirit and scope of the invention as hereinafter claimed.

What is claimed is:

1. A multiple position handle for dragging a weight comprises:
a structural body;
a first rope hole;
a handle hole;
a first set of finger notches;
the structural body comprises an inner lateral surface and an outer lateral surface;
the handle hole traversing through the structural body;
the inner lateral surface being delineated by the handle hole;
the first rope hole traverses through the structural body;
the first set of finger notches being integrated into a palm-width section of the inner lateral surface;
the first rope hole traversing through the structural body parallel to the handle hole;
the first rope hole being positioned adjacent to the handle hole, opposite to the first set of finger notches; and
the first rope hole being centrally orientated with the palm-width section.

2. The multiple position handle for dragging a weight as claimed in claim 1 comprises:
a left wing;
a second set of finger notches;
a second rope hole;
the left wing being connected adjacent to the structural body;
the left wing being positioned opposite to the first set of finger notches across the handle hole;
the left wing being positioned adjacent to the first rope hole;
the second set of finger notches being integrated into a distal longitudinal lateral surface of the left wing;
the second rope hole traversing through the left wing; and
the second rope hole being oriented parallel to the first rope hole.

3. The multiple position handle for dragging a weight as claimed in claim 1 comprises:
a right wing;
a third set of finger notches;
a third rope hole;
the right wing being connected adjacent to the structural body;
the right wing being positioned opposite to the first set of finger notches across the handle hole;
the right wing being positioned adjacent to the first rope hole, opposite a left wing;
the third set of finger notches being integrated into a distal longitudinal lateral surface of the right wing;
the third rope hole traversing through the right wing; and
the third rope hole being oriented parallel to the first rope hole.

4. The multiple position handle for dragging a weight as claimed in claim 1 comprises:
the structural body comprises a first portion and a second portion; and
the first portion being hingedly connected to the second portion.

5. The multiple position handle for dragging a weight as claimed in claim 1 comprises:
the structural body comprises a reinforced section; and
the reinforced section is positioned around the first rope hole.

6. A multiple position handle for dragging a weight comprises:
a structural body;
a first rope hole;
a handle hole;
a first set of finger notches;
the structural body comprises an inner lateral surface and an outer lateral surface;
the handle hole traversing through the structural body;
the inner lateral surface being delineated by the handle hole;
the first rope hole traverses through the structural body;
the first set of finger notches being integrated into a palm-width section of the inner lateral surface;
the first rope hole traversing through the structural body parallel to the handle hole;
the first rope hole being positioned adjacent to the handle hole, opposite to the first set of finger notches;
the first rope hole being centrally orientated with the palm-width section;
the structural body comprises a reinforced section; and
the reinforced section is positioned around the first rope hole.

7. The multiple position handle for dragging a weight as claimed in claim 6 comprises:
a left wing;
a second set of finger notches;
a second rope hole;
the left wing being connected adjacent to the structural body;
the left wing being positioned opposite to the first set of finger notches across the handle hole;
the left wing being positioned adjacent to the first rope hole;
the second set of finger notches being integrated into a distal longitudinal lateral surface of the left wing;
the second rope hole traversing through the left wing; and
the second rope hole being oriented parallel to the first rope hole.

8. The multiple position handle for dragging a weight as claimed in claim 6 comprises:
a right wing;
a third set of finger notches;
a third rope hole;
the right wing being connected adjacent to the structural body;
the right wing being positioned opposite to the first set of finger notches across the handle hole;
the right wing being positioned adjacent to the first rope hole, opposite a left wing;
the third set of finger notches being integrated into a distal longitudinal lateral surface of the right wing;
the third rope hole traversing through the right wing; and
the third rope hole being oriented parallel to the first rope hole.

9. The multiple position handle for dragging a weight as claimed in claim 6 comprises:
the structural body comprises a first portion and a second portion; and
the first portion being hingedly connected to the second portion.

10. A multiple position handle for dragging a weight comprises:
a structural body;
a first rope hole;
a handle hole;
a left wing;
a second set of finger notches;
a second rope hole;
a right wing;
a third set of finger notches;
a third rope hole;
a first set of finger notches;
the structural body comprises an inner lateral surface and an outer lateral surface;
the handle hole traversing through the structural body;
the inner lateral surface being delineated by the handle hole;
the first rope hole traverses through the structural body;
the first set of finger notches being integrated into a palm-width section of the inner lateral surface;
the first rope hole traversing through the structural body parallel to the handle hole;
the first rope hole being positioned adjacent to the handle hole, opposite to the first set of finger notches;
the first rope hole being centrally orientated with the palm-width section;
the left wing being connected adjacent to the structural body;
the left wing being positioned opposite to the first set of finger notches across the handle hole;
the left wing being positioned adjacent to the first rope hole;
the second set of finger notches being integrated into a distal longitudinal lateral surface of the left wing;
the second rope hole traversing through the left wing;
the second rope hole being oriented parallel to the first rope hole;
the right wing being connected adjacent to the structural body;
the right wing being positioned opposite to the first set of finger notches across the handle hole;
the right wing being positioned adjacent to the first rope hole, opposite a left wing;
the third set of finger notches being integrated into a distal longitudinal lateral surface of the right wing;
the third rope hole traversing through the right wing; and
the third rope hole being oriented parallel to the first rope hole.

11. The multiple position handle for dragging a weight as claimed in claim 10 comprises:
the structural body comprises a first portion and a second portion; and
the first portion being hingedly connected to the second portion.

12. The multiple position handle for dragging a weight as claimed in claim 10 comprises:
the structural body comprises a reinforced section; and
the reinforced section is positioned around the first rope hole.
